(19) United States
(12) Patent Application Publication
(10) Pub. No.: US 2024/0152068 A1
(43) Pub. Date: May 9, 2024

(54) IMAGE FORMING APPARATUS

(71) Applicant: CANON KABUSHIKI KAISHA, Tokyo (JP)

(72) Inventor: KOICHI TANIGUCHI, Tokyo (JP)

(21) Appl. No.: 18/492,211

(22) Filed: Oct. 23, 2023

(30) Foreign Application Priority Data
Nov. 8, 2022 (JP) 2022-178639

(51) Int. Cl. G03G 15/04; G03G 21/18

(52) U.S. Cl. CPC G03G 15/04036; G03G 21/1832

(57) ABSTRACT

An image forming apparatus includes an image carrier, an image forming unit, a measuring unit configured to measure the reflected light from the image carrier, a retaining member configured to retain the measuring unit, a shutter configured to block the light emitted from the light-emitting element, a spring member configured to pull the shutter to enter a closed state, a drive source, a drive control unit configured to control the drive source, a reference member, an adjustment unit configured to adjust the emitted light amount, and a control unit configured to control the image forming unit, the measuring unit, and the image forming unit, wherein, when the shutter enters the closed state from the open state, the drive control unit once stops the current supply to the drive source, then supplies a second current smaller than the first current to the drive source, and then stops the current supply again.

### BACKGROUND

### Field of the Disclosure

The present disclosure relates to control of opening and closing a shutter of a measuring unit provided on an image forming apparatus.

### Description of the Related Art

To correct relative image positional deviations (referred to as color deviations) and densities for different color components, image forming apparatuses such as copying machines, printers, and facsimiles form a measurement image on an image carrier, and control color deviations and densities based on the result of the measurement of the measurement image by a measuring unit. An optical sensor known as a measuring unit measures a measurement image formed on an intermediate transfer member (or a photosensitive drum) as an image carrier.

The optical sensor irradiates the measurement image on the image carrier with light by using a light-emitting element, and measures the reflected light from the image carrier and the reflected light from the measurement image. An image forming apparatus controls color or density deviations based on the reflected light amount measured by the optical sensor.

It is, however, necessary to shorten the distance between the optical sensor and the measurement image to measure the measurement image. For this reason, there is an issue that the reflected light amount is reduced by an agent (toner or ink) which is scattered from the measurement image and adheres to the surface of the optical sensor.

An image forming apparatus discussed in Japanese Patent Application Laid-Open No. 02-111162 includes a reference member for adjusting the emitted light amount of an optical sensor. Before measuring the measurement image, the image forming apparatus discussed in Japanese Patent Application Laid-Open No. 02-111162 enables the optical sensor to measure the reflected light from the reference member and adjusts the emitted light amount of the optical sensor based on the result of the measurement of the reflected light from the reference member. The configuration discussed in Japanese Patent Application Laid-Open No. 02-111162 adjusts the emitted light amount to correct the reflected light amount reduced by the toner adhesion, making it possible to accurately measure the reflected light from the measurement image even if toner adheres to the optical sensor.

It was found that the emitted light amount of the light-emitting element cannot be suitably adjusted because of a slight change of the distance from the light-emitting element of the measuring unit to the reference member. An experiment of the inventor revealed that the reflected light amount changes by as large as 4% when the distance between the object under measurement and the optical sensor changes by 0.1 mm. The variation of the reflected light amount by the above-described distance exceeds the reflected light amount reduced by stain of toner.

When the measurement image is measured by the optical sensor, the reference member needs to be evacuated from the optical path for the light from the light-emitting element. For this reason, the image forming apparatus includes a drive source for controlling the shutter to enter an open state. The image forming apparatus includes a spring member for closing the shutter. When restoring the shutter from the open state to a closed state, the drive source control is stopped, and the spring member brings the shutter to into contact with an abutting portion. Then, the state of the shutter changes from the open state to the closed state.

In a configuration for closing the shutter by using the above-described spring member, the shutter collides with the abutting portion, causing a variation in the distance between the reference member of the shutter and the optical sensor. This variation of the distance may possibly inhibit the suitable adjustment of the light amount of the optical sensor.

### SUMMARY

According to an aspect of the present disclosure, an image forming apparatus includes an image carrier, an image forming unit configured to form an image on the image carrier, a measuring unit provided with a light-emitting element for emitting light to the image carrier and a light-receiving element for receiving reflected light from the image carrier, and configured to measure the reflected light from the image carrier, a retaining member configured to retain the measuring unit, a shutter configured to block the light emitted from the light-emitting element of the measuring unit to the image carrier, a spring member configured to pull the shutter so that the shutter comes into contact with an abutting portion of the retaining member to enter a closed state where the shutter blocks the light emitted from the light-emitting element to the image carrier, a drive source, a drive control unit configured to control the drive source to separate the shutter from the abutting portion of the retaining member against a pulling force of the spring member so that the shutter enters an open state where the image carrier is irradiated with the light from the light-emitting element, a reference member disposed on the shutter, an adjustment unit configured to cause the light-emitting element of the measuring unit to emit light, cause the light-receiving element of the measuring unit to receive reflected light from the reference member, and adjust the emitted light amount of the light-emitting element based on a result of the measurement of the reference member by the measuring unit, and a control unit configured to control the image forming unit to form a measurement image, control the drive control unit to supply a first current to the drive source so that the shutter enters the open state, control the measuring unit to measure reflected light from the measurement image, and control the image forming unit based on a result of the measurement of the measurement image by the measuring unit, wherein, in a case where the shutter is controlled to enter the closed state from the open state, the drive control unit once stops the current supply to the drive source, then supplies a second current smaller than the first current to the drive source, and then stops the current supply again.

Further features of the present disclosure will become apparent from the following description of exemplary embodiments with reference to the attached drawings.

### BRIEF DESCRIPTION OF THE DRAWINGS

FIG. 1 is a cross-sectional view illustrating an essential part of an image forming apparatus.

FIG. 2 is a cross-sectional view schematically illustrating an optical sensor.

FIG. 3 is a control block diagram illustrating the image forming apparatus.

FIG. 4 schematically illustrates a color deviation detection pattern.

FIG. 5 illustrates an example of a result of detection of the color deviation detection pattern.

FIG. 6 schematically illustrates a density detection pattern.

FIG. 7 illustrates an example of a result of detection of the density detection pattern.

FIG. 8 is a perspective view schematically illustrating a sensor unit including the optical sensor.

FIG. 9 is a perspective view schematically illustrating a sensor holder.

FIG. 10 schematically illustrates an essential part of the sensor unit including a moving mechanism of a protection shutter.

FIGS. 11A and 11B are enlarged views illustrating an essential part of the protection shutter of the sensor unit.

FIGS. 12A and 12B illustrate a variation of the position of the protection shutter.

FIG. 13 illustrates an example of distance characteristics of the optical sensor.

FIG. 14 illustrates opening and closing timings of the protection shutter.

FIG. 15 is a flowchart illustrating control of opening and closing the protection shutter.

FIG. 16 is a flowchart illustrating light amount adjustment for the optical sensor.

### DESCRIPTION OF THE EMBODIMENTS

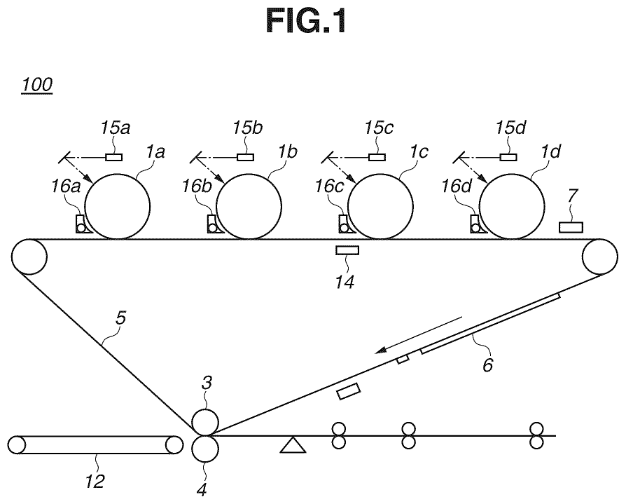

A first exemplary embodiment will be described below. FIG. 1 is a cross-sectional view illustrating an essential part of an image forming apparatus 100. The image forming apparatus 100 includes an image forming unit for forming a yellow (Y) image, a cyan (C) image, a magenta (M) image and a black (K) image, an intermediate transfer belt 5, and a transfer roller 4 for transferring the images on the intermediate transfer belt 5 to a sheet.

The image forming unit includes photosensitive drums 1a, 1b, 1c and 1d, a charging unit (not illustrated), laser scanners 15a, 15b, 15c, and 15d, developing devices 16a, 16b, 16c, and 16d, and a primary transfer unit (not illustrated). Referring to FIG. 1, the photosensitive drums 1a, 1b, 1c, and 1d rotate in the counterclockwise direction. The charging unit charges the photosensitive drums 1a, 1b, 1c, and 1d. The laser scanners 15a, 15b, 15c, and 15d expose the photosensitive drums 1a, 1b, 1c, and 1d charged by the charging unit to light to form electrostatic latent images on the photosensitive drums 1a, 1b, 1c, and 1d, respectively. The latent images on the photosensitive drums 1a, 1b, 1c, and 1d are developed by the developing devices 16a, 16b, 16c, and 16d, respectively. The images of different colors are visualized on the photosensitive drums 1a, 1b, 1c, and 1d.

The primary transfer unit transfers the images on the photosensitive drums 1a, 1b, 1c, and 1d from the photosensitive drums 1a, 1b, 1c, and 1d to the intermediate transfer belt 5. When the images of different colors formed on the photosensitive drums 1a, 1b, 1c, and 1d are sequentially transferred onto the intermediate transfer belt 5 in an overlapped way, a full-color image 6 is carried on the intermediate transfer belt 5. The intermediate transfer belt 5 is an intermediate transfer member to which images are transferred.

The intermediate transfer belt 5 is stretched by a plurality of rollers including a belt support roller. The image 6 is secondarily transferred from the intermediate transfer belt 5 to a sheet at the nip portion between the intermediate transfer belt 5 and the transfer roller 4. The sheet with the image 6 transferred thereto is conveyed to a fixing unit (not illustrated) by a conveyance belt 12. The image is fixed to the sheet with the heat and pressure from the fixing unit. The sheet with the image fixed thereto is discharged onto a discharge tray of the image forming apparatus 100.

The image forming apparatus 100 produces relative positional deviations between images of different colors by manufacturing dispersion or errors of the laser scanners 15a to 15d and the photosensitive drums 1a to 1d, parts distortion caused by temperature rise, and conveyance dispersion of the intermediate transfer belt 5. These relative positional deviations between images of different colors are referred to as color deviations. Accordingly, the image forming apparatus 100 forms a color deviation detection pattern, detects the color deviation detection pattern by using a pattern detection sensor 7, and performs color deviation correction based on the result of the detection of the color deviation detection pattern by using the pattern detection sensor 7 to prevent color deviations.

The image forming apparatus 100 is known to produce varying density of an image because of variations of the ambient environment (temperature and humidity) and the abrasion of photosensitive layers of the photosensitive drums 1a to 1d. For this reason, the image forming apparatus 100 forms a density detection pattern, detects the density detection pattern by using the pattern detection sensor 7, and controls image forming conditions based on the result of the detection of the density detection pattern by using pattern detection sensor 7 to achieve a target image density. Examples of the image forming conditions include the exposure intensities of the laser scanners 15a to 15d, and a gradation correction table of an image processing unit (not illustrated) for subjecting image data to image processing. Examples of the image forming conditions further include both the exposure intensities of the laser scanner 15a to 15d and the gradation correction table, and a charging bias applied to enable the charging unit (not illustrated) to charge the photosensitive drums 1a to 1d.

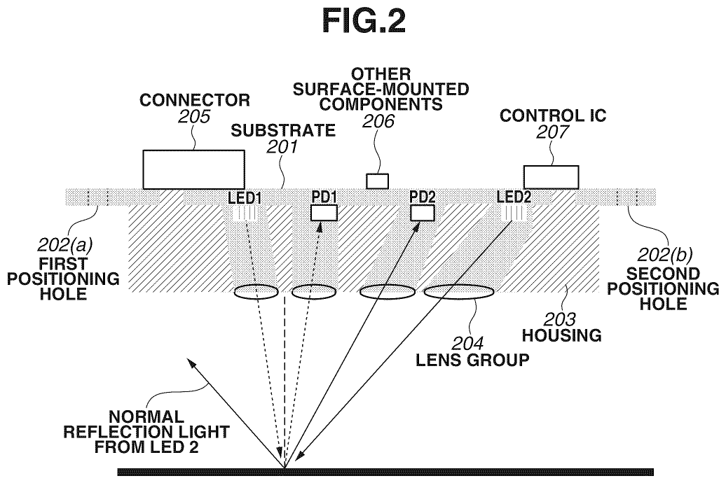

The pattern detection sensor 7 is an optical sensor for detecting the reflected light from the detection pattern (the density detection pattern or the color deviation detection pattern) formed on the intermediate transfer belt 5. The detection pattern is equivalent to the measurement image. FIG. 2 is a cross-sectional view schematically illustrating the pattern detection sensor 7. The pattern detection sensor 7 includes, for example, Light Emitting Diodes (LEDs) as light-emitting elements, and photodiodes (PDs) as light-receiving elements. The pattern detection sensor 7 includes two LEDs and two PDs. LEDs 1 and 2 and PDs 1 and 2 are disposed on the first surface of a substrate 201.

The LED 1 irradiates the surface of the intermediate transfer belt 5 with light, for example, at an incident angle of 7 degrees. The PD 1 receives, from the intermediate transfer belt 5, normal reflection light of the light radiated from the LED 1 onto the intermediate transfer belt 5. The PD 1 is disposed at a position where the PD 1 receives the light reflected by the intermediate transfer belt 5 at a reflection angle of 7 degrees. The LED 2 irradiates the surface of the intermediate transfer belt 5 with light, for example, at an incident angle of 35 degrees.

The PD 2 is a light-receiving element for receiving diffused reflected light from the intermediate transfer belt 5 (or the detection pattern on the intermediate transfer belt 5). The PD 2 is positioned between the LEDs 1 and 2 in the longitudinal direction of the substrate 201, and is disposed at a position where the PD 2 receives neither the normal reflection light of the light radiated from the LED 1 onto the intermediate transfer belt 5 nor the normal reflection light of the light radiated from the LED 2 onto the intermediate transfer belt 5. The PD 2 is disposed at a position where the PD 2 receives the light reflected by the intermediate transfer belt 5 at a reflection angle of 18 degrees.

All of the LEDs 1 and 2 and the PD 1 and 2 are surface-mounted elements disposed on the same surface of the substrate 201. The substrate 201 is provided with a housing 203. The housing 203 includes a shading wall and a lens group 204 for forming a light guide path for each element. Thus, the light emitted from the LED 1 advances in the direction of the optical axis (the dotted line in FIG. 2) and then radiated onto the intermediate transfer belt 5.

The light emitted from the LED 1 advances almost in the direction of the optical axis (the dotted line in FIG. 2) through a light guide path and a lens unit near the LED 1 of the lens group 204 in the housing 203, passes through a light guide path and a lens unit near the PD1 of the lens group 204 in the housing 203, and then reaches the PD 1. The light emitted from the LED 2 advances in the direction of the optical axis (solid line in FIG. 2) through a light guide path and a lens unit near the LED 2 of the lens group 204 in the housing 203, and then is radiated onto the intermediate transfer belt 5. The PD 2 receives diffused reflected light of the light radiated from the LED 2 onto the intermediate transfer belt 5 through a light guide path and a lens unit near the PD 2 of the lens group 204 in the housing 203.

A connector 205, a control integrated circuit (IC) 207, and other surface-mounted components 206 are mounted on the back surface of the first surface (mount surface) of the substrate 201 where the LEDs 1 and 2 and the PDs 1 and 2 are mounted. The control IC 207 as an IC core chip is connected with the substrate 201 with wire bonding by using a chip-on-board method.

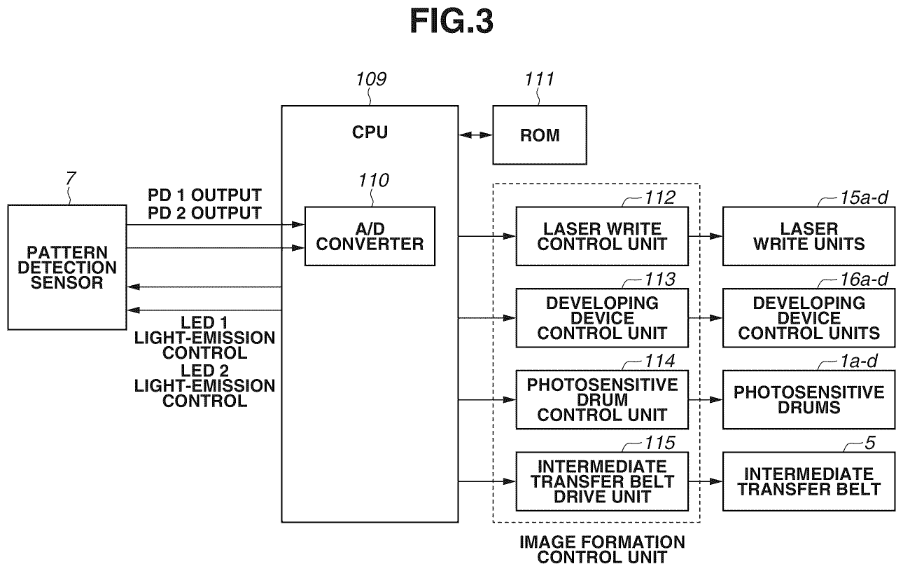

The connector 205 electrically connects a Central Processing Unit (CPU) 109 (FIG. 3) for controlling the entire image forming apparatus 100 and the pattern detection sensor 7. The control IC 207 communicates with the CPU 109 to control the light emission of the LEDs 1 and 2. Other surface-mounted components 206 include, for example, a capacitor for stabilizing the power to be supplied to the control IC 207.

The substrate 201 has a first positioning hole 202(a) and a second positioning hole 202(b) as openings for attaching the pattern detection sensor 7 to the image forming apparatus 100.

FIG. 3 is a control block diagram illustrating the image forming apparatus 100. The CPU 109 communicates with the control IC 207 to control the lighting of the LEDs 1 and 2 of the pattern detection sensor 7.

The pattern detection sensor 7 measures the reflected light from the intermediate transfer belt 5 or the detection pattern on the intermediate transfer belt 5, and outputs a voltage as an output value based on the result of the measurement (the result of the light reception of the PD 1 or 2). The voltage output by the pattern detection sensor 7 is converted into a digital signal by an analog-to-digital (A/D) converter 110 built in the CPU 109 and then acquired as a read level by the CPU 109.

The CPU 109 controls the laser scanners 15a to 15d via a laser write control unit 112, controls the developing devices 16a to 16d via a developing device control unit 113, and controls the photosensitive drums 1a to 1d via a photosensitive drum control unit 114. The CPU 109 controls the rotation of the drive rollers of the intermediate transfer belt 5 via an intermediate transfer belt drive unit 115.

Control by the CPU 109 will be described below. Control by the CPU 109 is performed based on program data stored in a Read Only Memory (ROM) 111. The CPU 109 controls the image forming unit to form a detection pattern (described below) on the intermediate transfer belt 5 based on pattern image data. The CPU 109 controls the pattern detection sensor 7 to detect the detection pattern and controls the image forming conditions based on the result of the detection of the detection pattern by the pattern detection sensor 7.

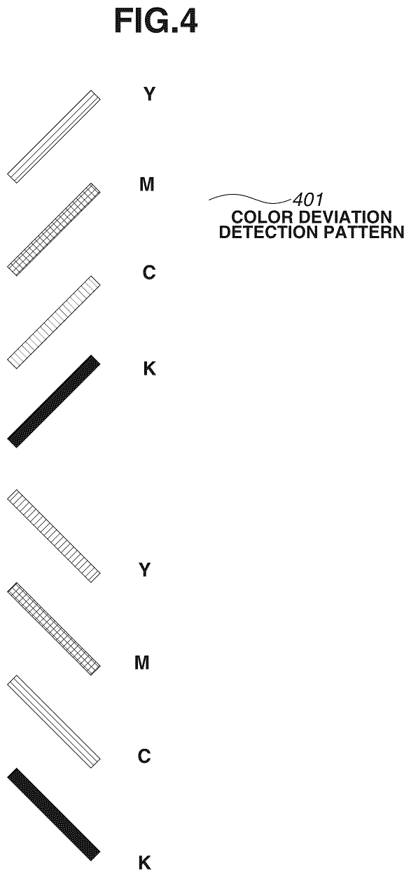

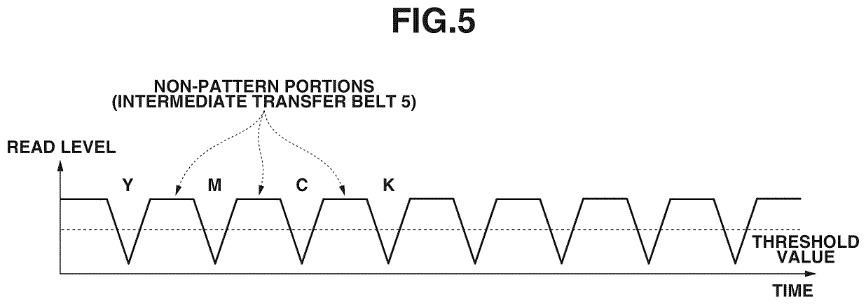

A detection pattern formed on the intermediate transfer belt 5 by the image forming apparatus 100 at the time of color deviation detection will be described below. FIG. 4 schematically illustrates a color deviation detection pattern 401 used to detect color deviations. FIG. 5 illustrates an example of a result of the detection of the color deviation detection pattern 401 by the pattern detection sensor 7 (an output waveform of the pattern detection sensor 7). To detect the color deviation detection pattern 401, the pattern detection sensor 7 causes the LED 1 to emit light and outputs a voltage value (output value) based on the result of the light reception by the PD 1.

In regions on the intermediate transfer belt 5 where the color deviation detection pattern 401 is not formed, the reflection factor of the surface of the intermediate transfer belt 5 is higher than that of the color deviation detection pattern 401 (toner image), resulting in a high voltage value of the PD 1 that receives normal reflection light and therefore resulting in an increased read level. On the other hand, in regions where the color deviation detection pattern 401 is formed, the reflection factor of the color deviation detection pattern 401 (toner images) is smaller than that of the surface of the intermediate transfer belt 5, resulting in a low voltage value of the PD 1 and therefore resulting in a decreased read level. In the color deviation detection, the CPU 109 compares the read level with a threshold value to detect the positions of the images of different colors included in the color deviation detection pattern 401, as illustrated in FIG. 5.

Based on the output waveform of the pattern detection sensor 7, the CPU 109 detects the difference between the positions of the images of different colors and ideal positions, as the amounts of color deviations. In the color deviation correction, the CPU 109 controls the write timings of the laser scanners 15a to 15d based on the detected color deviations via the laser write control unit 112.

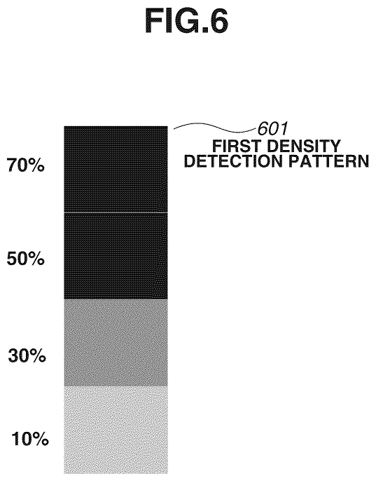

A detection pattern formed on the intermediate transfer belt 5 by the image forming apparatus 100 at the time of density detection will be described below. FIG. 6 schematically illustrates a density detection pattern 601 used for density detection. The density detection pattern 601 includes a gradation pattern having four different densities as 70%, 50%, 30%, and 10% of the maximum density (100%).

The CPU 109 detects the density detection pattern 601 formed on the intermediate transfer belt 5 via the pattern detection sensor 7 and converts the voltage value of the pattern detection sensor 7 into a digital value via the A/D converter 110 to acquire a read level. The CPU 109 converts the read level into an image density value (not illustrated), obtains the gradation characteristics of the image forming unit based on the density of the density detection pattern 601, and generates a gradation correction table so that the gradation characteristics are ideal gradation characteristics. Alternatively, the CPU 109 controls the image forming conditions based on the result of the detection of the pattern detection sensor 7 to achieve a target density.

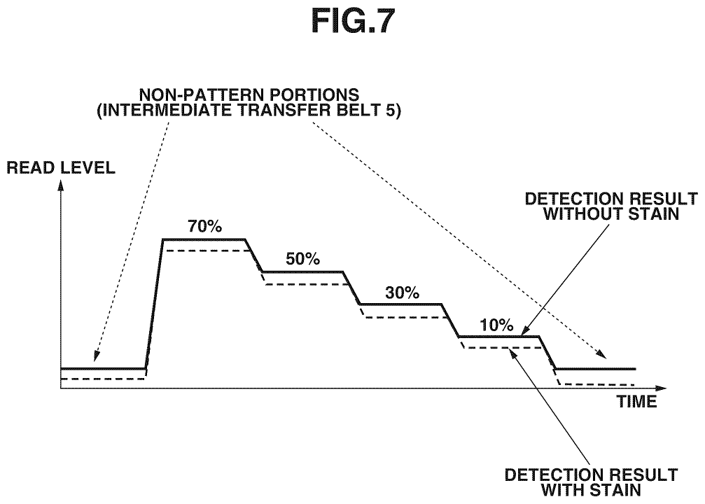

FIG. 7 illustrates an example of a result of the detection of the density detection pattern 601 of yellow detected by the pattern detection sensor 7 (an output waveform of the pattern detection sensor 7). To detect the density detection pattern 601, the pattern detection sensor 7 causes the LED 2 to emit light and outputs a voltage value (output value) based on the result of the light reception by the PD 2. For the density detection pattern 601 of other colors, the detection result has different voltage values and the same output waveform, and redundant descriptions of the other colors will be omitted.

An image having the 70% density included in the density detection pattern 601 has a large amount of toner, providing a large amount of diffused reflected light reflected by the yellow (Y) toner. With the increase in the received light amount of the PD 2, the voltage value of the pattern detection sensor 7 increases to increase the read level. An image having the 10% density included in the density detection pattern 601 has a small amount of toner, providing a small amount of diffused reflected light reflected by the yellow (Y) toner. With the increase in the received light amount of the PD 2, the voltage value of the pattern detection sensor 7 decreases to decrease the read level.

### (Light Amount Correction for Pattern Detection Sensor 7)

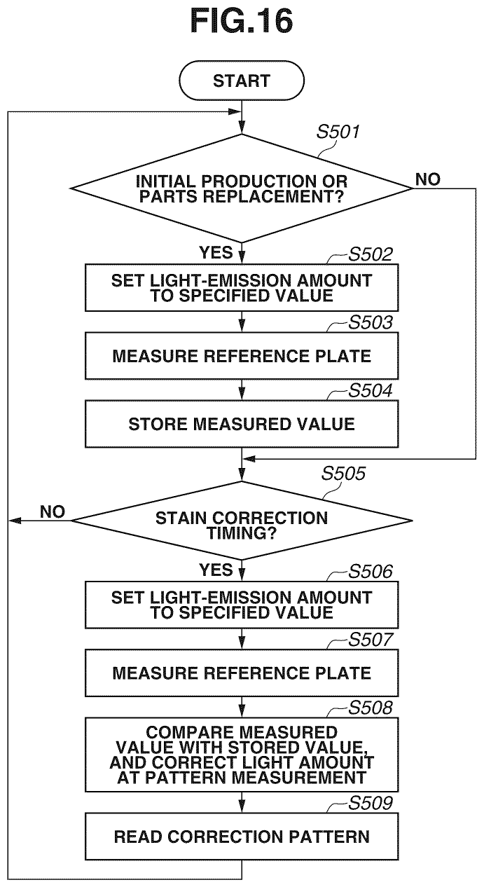

Since the pattern detection sensor 7 is disposed in the vicinity of the intermediate transfer belt 5, the sensor 7 is stained by toner scattered from the density detection pattern 601, resulting in a reduced reflected light amount. For example, as a result of the above-described density detection, the read level is lowered as drawn by the broken lines in FIG. 7. Accordingly, the image forming apparatus 100 performs control to adjust the emitted light amount of the pattern detection sensor 7 at an optional timing (FIG. 16).

The light amount adjustment will be described below with reference to the control flowchart in FIG. 16.

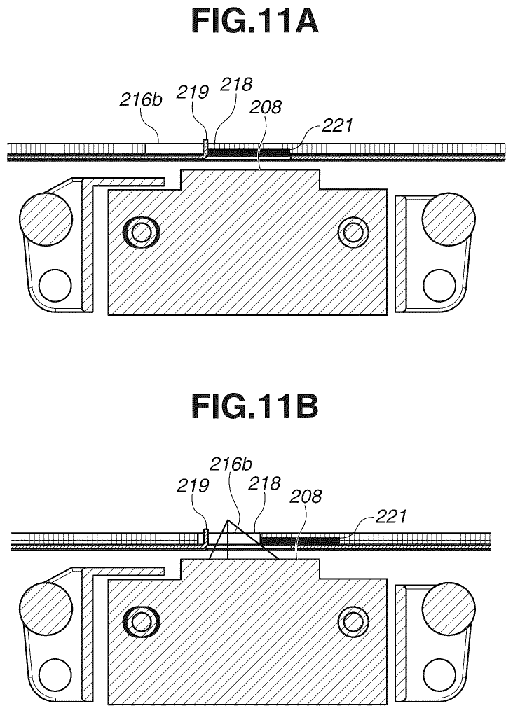

When the main power of the image forming apparatus 100 is turned ON, then in step S501, the CPU 109 determines whether the apparatus 100 is in the initial production or the parts replacement state. When the apparatus 100 is in the initial production or the parts replacement state (YES in step S501), the processing proceeds to step S502. In step S502, the CPU 109 sets the emitted light amount to a predetermined value. In step S503, the CPU 109 controls the pattern detection sensor 7 to measure the reflected light from a reference plate 221 (FIGS. 11A and 11B). In step S504, the CPU 109 stores the measured value acquired in step S503 in a memory (not illustrated) as a reference value. The reference plate 221 functions as a reference member for acquiring a reference value.

In step S505, the CPU 101 determines whether the current timing is a stain correction timing. For example, when the detection pattern 601 is to be read (YES in step S505), the CPU 109 performs the light amount adjustment before the detection pattern reading is started. Then, the processing proceeds to step S506. For example, the processing may proceed to step S506 when the number of sheets on which printing has been completed since the light amount adjustment is started reaches a predetermined number.

In step S506, the CPU 109 sets the emitted light amount to a predetermined value. In step S507, the CPU 109 controls the pattern detection sensor 7 to measure the reflected light from the reference plate 221 (FIGS. 11A and 11B). In step S508, the CPU 109 obtains the difference between the reference value stored in step S504 and the present measured value, and adjusts the emitted light amount so that the measured value of the reference plate 221 (FIGS. 11A and 11B) becomes the reference value. In step S509, the CPU 109 controls the pattern detection sensor 7 to detect the detection pattern based on the adjusted emitted light amount. When the detection of the detection pattern is successful, the CPU 109 controls the image forming conditions based on the result of the detection of the detection pattern.

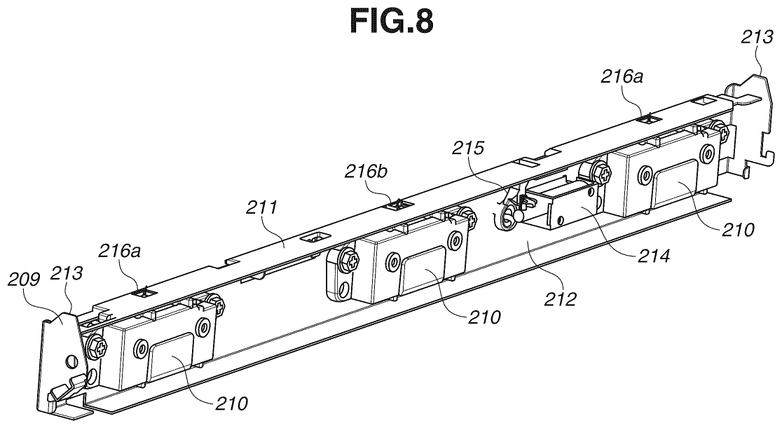

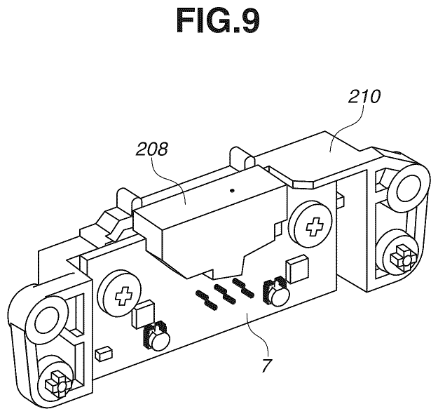

A sensor unit 200 will be described below. FIG. 8 is a perspective view schematically illustrating the sensor unit 200 as a retaining member for retaining the pattern detection sensor 7. FIG. 9 is a perspective view schematically illustrating a sensor holder 210. The sensor unit 200 is an assembly part for unitizing the pattern detection sensor 7, a protection shutter 211, and the reference plate 221.

The sensor unit 200 includes the pattern detection sensor 7, a frame 209, the sensor holder 210 for attaching the pattern detection sensor 7, and the protection shutter 211 for protecting a sensor surface 208 of the pattern detection sensor 7. The sensor surface 208 is the side where the lens group 204 (FIG. 2) of the housing 203 (FIG. 2) is disposed. The protection shutter 211 is provided with the reference plate 221 (FIGS. 11A and 11B) on the surface facing the sensor surface 208 of the pattern detection sensor 7.

The sensor unit 200 includes a shutter moving unit 212 for opening and closing the protection shutter 211. With the sensor unit 200, a frame positioning portion 213 disposed on the frame 209 is attached to the image forming apparatus 100 in a state of being biased by a positioning portion (not illustrated) disposed on the image forming apparatus 100. The sensor unit 200 is disposed in the image forming apparatus 100 to maintain a predetermined distance between the intermediate transfer belt 5 and the pattern detection sensor 7.

### (Moving Mechanism of Protection Shutter)

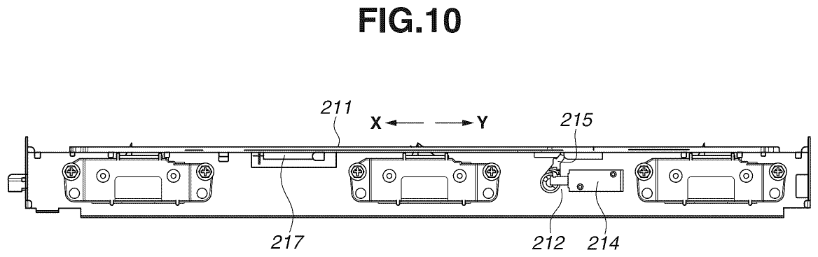

The moving mechanism of the protection shutter 211 will be described below with reference to FIGS. 8 and 10.

The protection shutter 211 is opened and closed by a solenoid 214 and a link 215 disposed on the shutter moving unit 212. The solenoid 214 is a drive source for changing the protection shutter 211 from the closed state to the open state. When the solenoid 214 is not absorbed, the protection shutter 211 is biased in the X direction by the shutter spring 217 to enter the closed state. When the solenoid 214 absorbs the plunger, the protection shutter 211 moves in the Y direction via the link 215 to enter the open state. The X and Y directions intersect with the gravity direction. The moving direction of the protection shutter 211 is not limited to the direction (horizontal direction) perpendicularly intersecting the vertical direction.

The protection shutter 211 is provided with an opening 216 to enable the pattern detection sensor 7 to detect the surface of the intermediate transfer belt 5. When the protection shutter 211 is in the open state, the sensor surface 208 is exposed from the opening 216, enabling the pattern detection sensor 7 to receive the reflected light from the intermediate transfer belt 5. The opening 216 enables the pattern detection sensor 7 to detect the detection pattern on the intermediate transfer belt 5 when the protection shutter 211 is in the open state.

On the other hand, when the protection shutter 211 is in the closed state, the protection shutter 211 blocks the light emitted from the light-emitting element (LED 1 or 2) of the pattern detection sensor 7 to the intermediate transfer belt 5. When the protection shutter 211 is in the closed state, the protection shutter 211 disposed on the reference plate 221 (FIGS. 11A and 11B) faces the pattern detection sensor 7. This enables the pattern detection sensor 7 to detect the reference plate 221 (FIGS. 11A and 11B) when the protection shutter 211 is in the closed state.

FIGS. 11A and 11B are enlarged views illustrating an essential part of the sensor unit 200. FIG. 11A illustrates the protection shutter 211 in the closed state, and FIG. 11B illustrates the protection shutter 211 in the open state. When the protection shutter 211 is changed from the open state to the closed state by the shutter spring 217, the shutter positioning portion 218 disposed on the lateral surface of the opening 216 comes into contact with a shutter abutting portion 219 disposed on the frame 209, and the protection shutter 211 stops. Thus, the protection shutter 211 enters the closed state to prevent the pattern detection sensor 7 from being stained by scattered toner. The shutter spring 217 functions as a spring member for pulling the protection shutter 211 so that the shutter positioning portion 218 comes into contact with the shutter abutting portion 219.

### (Opening and Closing Operations of Protection Shutter 211)

The timing of opening and closing the protection shutter 211 will be described below. The protection shutter 211 has a function of preventing stain in addition to a function of detecting the above-described detection pattern and a function of detecting the reference plate 221. Accordingly, the protection shutter 211 is basically closed other than in a case of detecting the detection pattern. More specifically, the pattern detection sensor 7 faces the reference plate 221 to enable measuring the reference plate 221 in a time period during which the detection pattern is not detected.

In recent years, users have demanded higher productivity. For this reason, the detection pattern is formed between images formed on the intermediate transfer belt 5. The absorption operation of the solenoid 214 (plunger) opens the protection shutter 211 for about several ten milliseconds and then maintains the absorption state. Then, upon completion of the detection pattern measurement, the protection shutter 211 is changed from the open state to the closed state by the shutter spring 217. As described above, the protection shutter 211 (the positioning portion 218 of the protection shutter 211) collides with the abutting portion 219 in a short-time closing operation.

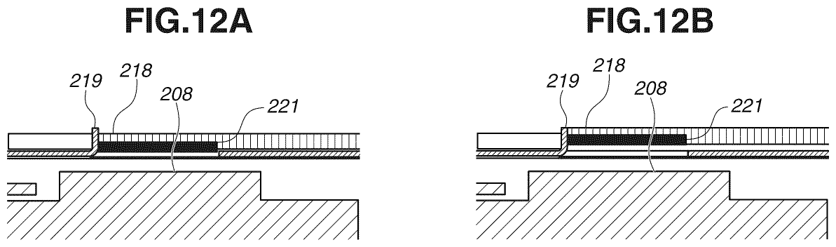

An experiment by the inventor revealed that the short-time closing operation of the protection shutter 211 caused the vertical movement of the protection shutter 211. FIG. 12A illustrates an ideal stop position in the closed state of the protection shutter 211. On the other hand, FIG. 12B illustrates the stop position of the protection shutter 211 when the protection shutter 211 stops at a position vertically deviated from the ideal stop position. The protection shutter 211 is biased by the shutter spring 217 while the protection shutter 211 is in contact with the abutting portion 219. Accordingly, as illustrated in FIG. 12B, the protection shutter 211 stops at a position vertically deviated from the ideal stop position because of the frictional force applied between the abutting portion 219 and the positioning portion 218 of the protection shutter 211. This means that the distance between the reference plate 221 and the pattern detection sensor 7 is not the ideal distance.

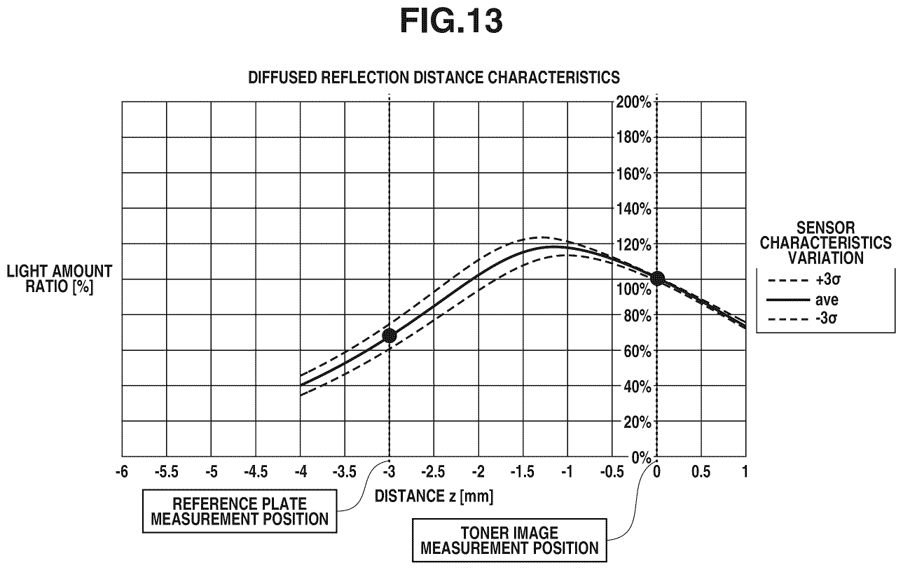

FIG. 13 illustrates the distance characteristics of the pattern detection sensor 7 obtained through an experiment by the inventor. The distance characteristics indicate the variation of the reflected light amount with respect to the distance from the pattern detection sensor 7 to a target object. FIG. 13 illustrates that the reflected light amount largely is changed by the distance from the pattern detection sensor 7 to the target object. More specifically, when the target object is located at a position 3 mm from the pattern detection sensor 7, the reflected light amount changes by as large as 4% with respect to a 0.1-mm variation.

After the positioning portion 218 of the protection shutter 211 is brought into contact with the abutting portion 219 by the shutter spring 217, the image forming apparatus 100 performs the absorption operation of the solenoid 214 (plunger) (operation for opening the protection shutter 211). This operation is referred to as a post operation. In the post operation, the protection shutter 211 moves to an extent that the sensor surface 208 is not entirely exposed from the opening 216. More specifically, the moving amount of the protection shutter 211 in the post operation is smaller than that of the protection shutter 211 when the protection shutter 211 changes from the closed state to the open state to enable the pattern detection sensor 7 to detect the detection pattern on the intermediate transfer belt 5. When the post operation is completed, the positioning portion 218 is brought into contact with the abutting portion 219 by the shutter spring 217, and the protection shutter 211 enters the closed state again. After the post operation is performed, the impact occurring when the positioning portion 218 is brought into contact with the abutting portion 219 is smaller than the impact caused by the closing operation immediately after the detection of the detection pattern. Accordingly, the protection shutter 211 is positioned at the ideal stop position in the closed state. Performing the post operation can prevent the variation of the distance from the pattern detection sensor 7 to the reference plate 221 during execution of the light amount adjustment of the pattern detection sensor 7, so that the pattern detection sensor 7 can suitably adjust the emitted light amount.

### (Opening and Closing Operations of Protection Shutter 211)

Control for positioning the protection shutter 211 at the target position through the post operation will be described below. The current applied to the solenoid 214 at the time of the post operation is made smaller than that at the time of detection pattern reading. The application time duration of the current applied to the solenoid 214 at the time of the post operation is made shorter than that of the current applied to the solenoid 214 at the time of detection pattern reading.

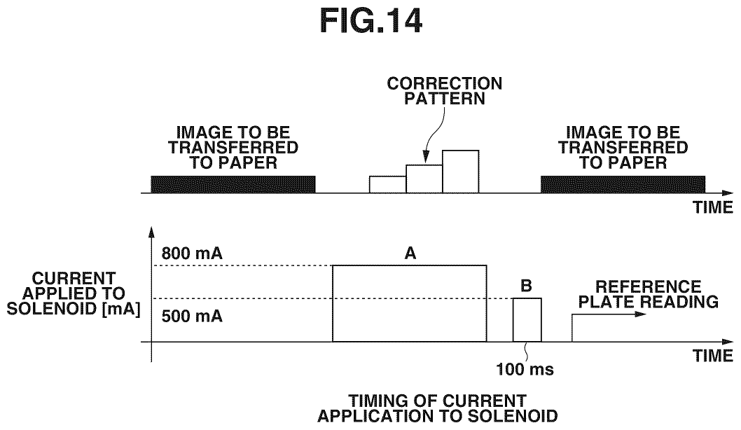

An example will be described below with reference to FIG. 14. A time period A indicates the time duration during which the opening and closing operation of the protection shutter 211 is performed at the time of detection pattern reading, and the magnitude of the current applied to the solenoid 214. A time period B indicates the time duration during which the post operation is performed, and the magnitude of the current applied to the solenoid 214. The applied current in the post operation (time period B) is made smaller than that at the time of detection pattern reading (time period A), and the applied current in the time period B is turned OFF in a shorter time than in the time period A. For example, the current applied to the solenoid 214 in the post operation is set to about 60% of that at the time of detection pattern reading. The current application time duration in the time period B is, for example, is 100 milliseconds.

The reason why the current applied in the time period B is set to about 60% of that in the time period A is to almost equalize the absorption force of the solenoid 214 (plunger) and the biasing force of the shutter spring 217. Thus, during the 100-ms current application time duration, the protection shutter 211 moves by almost the same force as the biasing force of the shutter spring 217. Actually, the absorption force required to open the protection shutter 211 and the force of the shutter spring 217 required to close the protection shutter 211 are almost the same, and therefore the protection shutter 211 hardly moves.

When the applied voltage is turned OFF after completion of the post operation, the positioning portion 218 is brought into contact with the abutting portion 219 again by the shutter spring 217, and the protection shutter 211 returns to the position of the closed state. After this operation, the protection shutter 211, which has vertically moved by the impact occurring when the protection shutter 211 is opened or closed after the detection of the detection pattern, moves to the ideal vertical position by its own weight. The protection shutter 211 hardly moves in the 100-ms period even after turning OFF the applied voltage, and hence the impact occurring when the positioning portion 218 is brought into contact with the abutting portion 219 decreases. For this reason, the positions of the protection shutter 211 and the pattern detection sensor 7 are stably set to the ideal positions in the closed state after the post operation.

### (Opening and Closing Control of Protection Shutter)

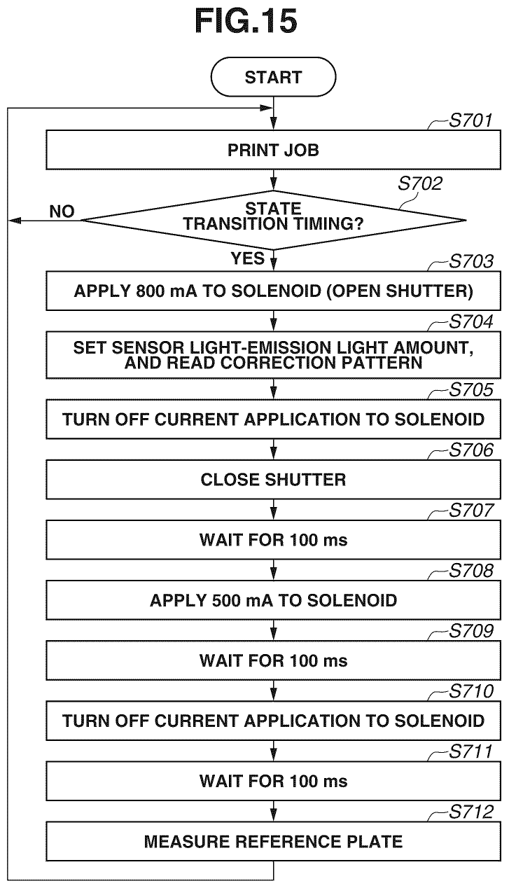

Opening/closing control of the protection shutter will be described below with reference to the control block diagram in FIG. 3 and the flowchart in FIG. 15. In step S701, the CPU 109 starts a job in which the image forming apparatus 100 forms an image on a sheet. When the number of pages on which image printing has been completed reaches a predetermined number during execution of the job (YES in step S702), the processing proceeds to step S703. In step S703, the CPU 109 instructs the image forming unit to form a detection pattern. In step S703, the CPU 109 applies a current to the solenoid 214 to change the protection shutter 211 from the closed state to the open state. In step S703, the CPU 109 applies, for example, an 800-mA current to the solenoid 214. The CPU 109 functions as a drive control unit for controlling the solenoid 214 as a drive source. Thus, the positioning portion 218 of the protection shutter 211 separates from the abutting portion 219.

In step S704, the CPU 109 controls the light-emitting element (LED 1 or 2) to emit light based on the emitted light amount adjusted by the sensor stain correction, and controls the pattern detection sensor 7 to measure the detection pattern. In step S704, because the 800-mA current is kept being applied to the solenoid 214, the protection shutter 211 remains open. After the detection pattern has passed through the detection position of the pattern detection sensor 7, then in steps S705 and S706, the CPU 109 turns OFF the current applied to the solenoid 214. Thus, the shutter spring 217 restores the protection shutter 211 to the former position.

In step S707, the CPU 109 waits for 100 milliseconds until the state of the protection shutter 211 stabilizes. In step S708, to perform the post operation, the CPU 109 applies a current, for example, a 500-mA current to the solenoid 214 again. After once stopping the current supply to the solenoid 214, the CPU 109 supplies the 500-mA current to the solenoid 214 again.

In step S709, the CPU 109 waits for 100 milliseconds while maintaining the current applied in step S708. In step S710, the CPU 109 turns OFF the current applied to the solenoid 214. In step S711, the CPU 109 waits for 100 milliseconds. In step S712, the CPU 109 controls the pattern detection sensor 7 to measure the reference plate 221 to perform the light amount adjustment.

The vertical positions of the reference plate 221 and the pattern detection sensor 7 are moved to the ideal positions through the post operation (the processing in steps S707 to S710). Accordingly, the processing of step S712 may be performed, for example, after completion of the processing in step S702. More specifically, when the distance between the reference plate 221 and the pattern detection sensor 7 is stable, the CPU 109 may be configured to control the pattern detection sensor 7 to measure the reference plate 221 before the detection pattern measurement.

Although, in the flowchart in FIG. 15, the pattern detection sensor 7 measures the reference plate 221 each time the detection pattern measurement is performed, the CPU 109 does not need to perform the processing in steps 707 to 712 each time. For example, if a small number of sheets have been printed since the last light amount adjustment, the CPU 109 may skip the processing in steps S707 to S712. The timing of the detection pattern measurement is not limited to the job execution timing. The light amount adjustment and detection pattern measurement may be performed when the user issues an instruction for the detection pattern measurement.

In the above descriptions, the current value (500 mA) applied to the solenoid 214 in the post operation is made smaller than the current value (800 mA) applied to the solenoid 214 at the time of the detection pattern measurement. However, if the current value (or voltage value) to be applied to the solenoid 214 cannot be changed, only the application time duration may be reduced. This configuration also enables obtaining similar effects.

A 500-mA current is to be applied to the solenoid 214 in the post operation to improve the stability of the position of the reference plate 221. However, the most suitable current value to be applied to the solenoid 214 depends on individual differences of the solenoid 214 and the shutter spring 217. Accordingly, for example, there may be provided a mode for determining the current value to be applied to the solenoid 214 in the post operation. For example, the CPU 109 needs to perform steps S703 to S712 in FIG. 15 several times while varying the applied current and then determine the most suitable current value based on the result of the measurement of the reference plate 221 by the pattern detection sensor 7.

Although, in the above descriptions, the CPU 109 controls the value of the current to be applied to the solenoid 214 to drive the protection shutter 211, the value of the applied voltage may be controlled. In this configuration, the CPU 109 may control the voltage to be applied to the solenoid 214 so that the applied voltage in the post operation becomes smaller than that at the time of detection pattern measurement.

The present disclosure makes it possible to suitably adjust the light amount of the measuring unit.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-178639, filed Nov. 8, 2022, which is hereby incorporated by reference herein in its entirety.

What is claimed is:

1. An image forming apparatus comprising:
an image carrier;
an image forming unit configured to form an image on the image carrier;
a measuring unit provided with a light-emitting element for emitting light to the image carrier and a light-receiving element for receiving reflected light from the image carrier, and configured to measure the reflected light from the image carrier;
a retaining member configured to retain the measuring unit;
a shutter configured to block the light emitted from the light-emitting element of the measuring unit to the image carrier;
a spring member configured to pull the shutter so that the shutter comes into contact with an abutting portion of the retaining member to enter a closed state where the shutter blocks the light emitted from the light-emitting element to the image carrier;
a drive source;
a drive control unit configured to control the drive source to separate the shutter from the abutting portion of the retaining member against a pulling force of the spring member so that the shutter enters an open state where the image carrier is irradiated with the light from the light-emitting element;
a reference member disposed on the shutter;
an adjustment unit configured to cause the light-emitting element of the measuring unit to emit light, cause the light-receiving element of the measuring unit to receive reflected light from the reference member, and adjust the emitted light amount of the light-emitting element based on a result of the measurement of the reference member by the measuring unit; and
a control unit configured to control the image forming unit to form a measurement image, control the drive control unit to supply a first current to the drive source so that the shutter enters the open state, control the measuring unit to measure reflected light from the measurement image, and control the image forming unit based on a result of the measurement of the measurement image by the measuring unit,
wherein, in a case where the shutter is controlled to enter the closed state from the open state, the drive control unit once stops the current supply to the drive source, then supplies a second current smaller than the first current to the drive source, and then stops the current supply again.

2. The image forming apparatus according to claim 1, wherein the drive source is a solenoid having a plunger.

3. The image forming apparatus according to claim 1, wherein the shutter is controlled to move in a direction intersecting with a gravity direction from the closed state to enter the open state.

4. An image forming apparatus comprising:
an image carrier;
an image forming unit configured to form an image on the image carrier;
a measuring unit provided with a light-emitting element for emitting light to the image carrier and a light-receiving element for receiving reflected light from the image carrier, and configured to measure the reflected light from the image carrier;
a retaining member configured to retain the measuring unit;
a shutter configured to block the light emitted from the light-emitting element of the measuring unit to the image carrier;
a spring member configured to pull the shutter so that the shutter comes into contact with an abutting portion of the retaining member to enter a closed state where the shutter blocks the light emitted from the light-emitting element to the image carrier;
a drive source;
a drive control unit configured to control the drive source to separate the shutter from the abutting portion of the retaining member against a pulling force of the spring member so that the shutter enters an open state where the image carrier is irradiated with the light from the light-emitting element;
a reference member disposed on the shutter;
an adjustment unit configured to cause the light-emitting element of the measuring unit to emit light, cause the light-receiving element of the measuring unit to receive reflected light from the reference member, and adjust the emitted light amount of the light-emitting element based on a result of the measurement of the reference member by the measuring unit; and
a control unit configured to control the image forming unit to form a measurement image, control the drive control unit to supply a first voltage to the drive source so that the shutter enters the open state, control the measuring unit to measure reflected light from the measurement image, and control the image forming unit based on a result of the measurement of the measurement image by the measuring unit,
wherein, in a case where the shutter is controlled to enter the closed state from the open state, the drive control unit once stops the voltage supply to the drive source, then supplies a second voltage smaller than the first voltage to the drive source, and then stops the voltage supply again.

5. The image forming apparatus according to claim 4, wherein the drive source is a solenoid having a plunger.

6. The image forming apparatus according to claim 4, wherein the shutter is controlled to move in a direction intersecting with a gravity direction from the closed state to enter the open state.
